(19) United States
(12) Patent Application Publication
(10) Pub. No.: US 2012/0222526 A1
(43) Pub. Date: Sep. 6, 2012

(54) DRIVE MOTOR

(75) Inventor: Günther Weber, Gross Nemerow (DE)

(73) Assignee: WEBER MASCHINENBAU GMBH BREIDENBACH, Breidenbach (DE)

(21) Appl. No.: 13/392,290

(22) PCT Filed: Jun. 16, 2010
(86) PCT No.: PCT/EP2010/003601

§ 371 Date: May 4, 2012

(30) Foreign Application Priority Data
Aug. 26, 2009 (DE) 10 2009 038 875.3

(51) Int. Cl. B26D 5/06; B26D 1/157; H02K 7/14; B26D 1/12

(52) U.S. Cl. 83/13; 83/613; 83/437.1; 310/12.14

(57) ABSTRACT

An apparatus for driving an object is provided, having a cutting blade for slicing food products. The apparatus includes an electric drive motor that is configured to drive the object to make rotational movements about an axis, and to make axial movements generally parallel to the axis.

### CROSS-REFERENCES TO RELATED APPLICATIONS

This patent application claims the benefit of priority to German Patent Application Serial No. 102009038875.3, filed Aug. 26, 2009, and claims the benefit of priority to International Patent Application Serial No. PCT/EP2010/003601, filed Jun. 16, 2010, each of which are incorporated herein by reference in their entirety.

### FIELD OF THE INVENTION

The invention relates to an electric drive motor for driving an object, in particular a cutting blade of an apparatus for slicing food products, and in particular a high performance slicer. The invention furthermore relates to an apparatus for slicing food products, in particular a high performance slicer. This slicing apparatus is in particular provided with a drive motor in accordance with an embodiment of the invention. The invention further relates to a blade head for an apparatus for slicing food products, in particular for a high performance slicer. The invention furthermore relates to the use of an electric drive motor in accordance with an embodiment of the invention in an apparatus for slicing food products, in particular in a high performance slicer. The invention also relates to a method for slicing food products.

### BACKGROUND

In many applications, it is necessary not only to set an object into rotation, but also to move the object parallel to the axis of rotation. It is in particular necessary in this respect to carry out the axial movement during the rotation operation, i.e. the object is moved in the axial direction while rotating. In particular high performance slicers for slicing food products are provided with one or more cutting blades, which either revolve in a planetary motion about an axis and additionally rotate about their own axis of rotation, or only about their own axis of rotation. The latter are in particular formed as so-called scythe-like blades or spiral blades. Planetary orbiting and simultaneously rotating cutting blades are, in contrast, in particular so-called circular blades. Slices are cut off food products such as meat, sausage, ham or cheese at high speed using such slicers. The cutting speed amounts to up to a few 1,000 slices per minute. That is, such slicers require a drive which is able to set the cutting blade into rotation at speeds of up to about several thousand revolutions per minute. The weight of a slicer blade typically amounts to approximately 5 kilograms for circular blades and up to 20 kilograms for scythe-like blades. In addition, there is the weight of a so-called blade carrier or of a blade receiver to which the cutting blade is respectively replaceably fastened. The blade carrier or the blade receiver must therefore likewise be set into rotation. The mass to be set into rotation in total by a slicer drive, i.e. so-to-say the “payload” of the drive without its own weight, is in this respect typically in the range from about 40 to 70 kilograms.

In many slicer applications, the cut-off product slices are not transported away individually, but so-called portions of product slices are rather formed in which the product slices lie over one another in stacked or overlapping form, for example. The transporting away of the cut-off product slices there takes place portion-wise, i.e. after formation of a slice portion, it must first be transported away from the portion formation zone into which the cut-off slices fall before the formation of the next slice portion can be started. The higher the cutting speed, the less time is available for the transporting away of the slice portions.

At cutting speeds from approximately 600 slices per minute onward, experience has shown that it is no longer possible to transport the slice portions away without disturbance, without the cutting off of product slices being temporarily interrupted. It is currently not possible to stop the cutting blade for such an interruption. It is rather the case that so-called blank cuts or blank strokes are achieved in which therefore no slices are cut off from the product despite the continued cutting movement of the blade in that the product supply is stopped. That is, the product is temporarily not moved further into the cutting zone of the blade.

For various reasons which are known and which will not be looked at in any more detail here, a so-called scrap formation or snippet formation occurs in practice. However, despite the interruption of the product feed, the cutting blade may cut off small product pieces from the product that is temporarily not being further advanced if no additional measure is taken to avoid the scrap formation, which may be unfavorable for a variety of reasons.

This additional measure comprises providing that a spacing is established between the blade, on the one hand, and the front product end, on the other hand, during the blank cuts. It is known for this purpose in accordance with an alternative either to retract the product alone, or the product together with at least some parts of the product feed or product support. This method may result in a number of applications in satisfactory results, but may be problematic due to the high demands on the mechanism required for the retraction movement, and may also be relatively difficult to realize at very high cutting speeds and/or with particularly heavy products.

In accordance with a further alternative, it is known not to move the product away from the blade, but rather to move the blade away from the product, to carry out blank cuts. This procedure may result in the masses to be moved being considerably smaller, but likewise requires a relatively complex mechanism. Some references known from the prior art for the establishing of a spacing between the cutting blade and the product to avoid scrap formation in blank cuts are described, for example, in patent applications EP 0 289 765 A1, DE 42 14 246 A1, EP 1 010 501 A2 and EP 1 046 476 B1.

All solutions known from the prior art, including those which relate to an axial movement of the blade away from the product, have in common that the required axial movement is realized with the aid of a less complex construction mechanism, and independently of whether a separate drive is provided for the axial movement or—in particular with an axial movement of the blade—the axial movement is derived at times, i.e. when blank cuts should be carried out, from the rotational drive of the blade in any desired manner.

In particular with modern high performance slicers, there is consequently a need for a blade drive which may allow an axial movement of the blade with a minimum use of mechanical means to carry out blank cuts. In this respect, not only the above-mentioned masses to be moved have to be taken into account. It is also important that the required axial adjustment path for the carrying out of blank cuts is admittedly relatively small and is typically in the range from about 1 millimeters to about 10 millimeters, but that this axial stroke must be covered by the blade within a relatively short time, which is typically in the range from about 0.02 seconds to about 0.5 seconds, with other time demands also being able to result depending on the application.

It must also be pointed out at this point that axial movements of the cutting blade of a slicer cannot only serve for carrying out blank cuts, but that there are moreover further situations in which an axial movement of the blade is required. It is thus required, for example, in dependence on the properties of the respective product to be sliced and on other conditions of the respective application to set the so-called cutting gap to a specific measurement. The cutting gap is the axial spacing between the plane defined by the blade edge of the blade, on the one hand, and the place defined by the so-called cutting edge, on the other hand. The cutting edge, which is also called a counter-blade, cooperates with the blade during the cutting process and forms the end of the product feed.

Methods of setting the cutting gap are known in a plurality of variants which are not discussed in detail. In some methods, the cutting gap setting takes place with a stationary (i.e. non-rotating), blade, with other methods also allowing a cutting gap setting with a rotating blade, in particular a blade rotating at a desired speed or at a cutting speed, which may be an improvement for various reasons. It is also desirable for the purpose of this cutting gap setting to be able to affect the axial movement of the blade required for this purpose with a minimum use of mechanical means.

### SUMMARY

Thus, in one embodiment of the invention, a drive with which a rotating object can be moved generally parallel to a respective axis of rotation with a minimum or reduced use of mechanical means. The drive in particular may be configured for the area of high performance slicers for carrying out blank cuts and/or for the cutting gap setting.

In this respect, in accordance with the invention, the electric drive motor is designed to drive the object to make rotational movements about an axis and to make axial movements generally parallel to the axis. The invention is thus based on providing the respective object with a single electric drive motor which, on the one hand, serves as a rotational drive for the object and, on the other hand, is also able to move the object in the axial direction. The invention hereby departs from the path taken in the prior art which comprises providing an additional drive of any type for the axial movement of the rotating object or to derive the required axial movement of the object from the rotational drive in any desired manner with the aid of mechanically complex means.

In one embodiment, the invention may thus allow the possibility, naturally without being generally restricted thereto, of further developing known electric rotational drives such that, in addition to a rotational drive, an axial movement of the respective object is possible as required so that only a single drive motor is required.

In one embodiment, the invention provides the possibility of fastening the blade directly to the motor, i.e. the motor or its outer region can simultaneously serve as a so-called blade carrier or blade receiver. This naturally does not preclude that a separate blade carrier or a separate blade receiver is provided, which is respectively fastened to the motor, on the one hand, and to which the blade is respectively replaceably attached, on the other hand.

Various embodiments of the invention are also set forth in the disclosure and in the drawings.

The motor may be configured for carrying out the axial movements simultaneously with the rotational movements.

The motor may include a rotor which can both be set into rotation about the axis, and can also be moved generally parallel to the axis.

The rotor may be provided with at least one electrically excitable coil.

In one embodiment of the invention, the at least one coil is configured and arranged to set the rotor only into rotation about the axis. An electromagnetic can be associated with the rotor for the axial movement in one embodiment. In such an embodiment, the rotational drive of the rotor thus takes place as with a conventional electric motor, whereas an electric magnet is provided for the axial movement which naturally acts on the rotor—as does the coil providing the rotational movement. No additional drive is thus necessary for the axial movement. In addition, no mechanical means are generally required for this axial movement.

In yet another embodiment, the rotor is provided with at least two electrically excitable coils by which the rotor can be set into rotation about the axis and can be moved parallel to the axis.

The coils may be excitable independently of one another.

In one embodiment, provisions may be made such that the coils affect the rotational movement and the axial movement together.

The coils may be arranged and/or excitable in opposite senses with respect to the axis. It is hereby possible to affect a rotation of the rotor by a suitable excitation of the coils, but in this respect as required either to avoid an axial movement of the rotor or to move the rotor temporarily in the axial direction in addition to the rotation.

Provision is made in an embodiment of the invention that at least one coil has a surface normal with a component generally parallel to the axis. It is hereby achieved that a force acting generally parallel to the axis is exerted on the rotor, and the rotor is thus moved in the axial direction.

At least one coil may have at least one diagonal winding.

In a further embodiment of the invention, the motor, and in particular the rotor of the motor, is formed as a carrier for a cutting blade, or can be connected to a separate carrier for a cutting blade.

The motor may be configured to drive an object whose weight is in the range from about 10 killograms to about 100 killograms. This weight is, in particular, so-to-say the payload of the motor.

In a further embodiment of the invention, the motor is configured to set the object into rotation at a speed ranging from about 100 to about several thousand revolutions per minute.

In a further embodiment of the invention, the motor is configured to carry out axial movements with a length of about 1 millimeter to about 10 millimeters within a time ranging from about 0.02 seconds to about 0.5 seconds.

The motor in accordance with an embodiment of the invention may be suitable as a drive for a cutting blade of a high performance slicer.

The slicing apparatus in accordance with an embodiment of the invention, in particular the high performance slicer in accordance with an embodiment of the invention, includes a product feed, at least one cutting blade to which at least one product to be sliced can be fed, and a single electric drive motor for the cutting blade. The cutting blade is drivable to make rotational movements about an axis and axial movements generally parallel to the axis by means of the drive motor. The drive motor may be the same drive motor as was described above.

A feed device of the slicing apparatus with which the product can be fed to the cutting blade may extend generally parallel to the axis of rotation of the cutting blade.

The slicing apparatus may be configured to move the cutting blade by means of the drive motor for carrying out blank cuts and/or for setting a cutting gap generally parallel to the axis.

The blade head in accordance with an embodiment of the invention for a slicing apparatus, in particular for a high performance slicer, includes a carrier for a cutting blade of the slicing apparatus as well as an electric drive motor in accordance with the invention as was described above. In this respect, the motor itself can be designed as a carrier for the cutting blade, or connectable to a separate carrier for the cutting blade.

The use in accordance with an embodiment of the invention, a method of utilizing the electric drive motor as was described above, may be used in a slicing apparatus, in particular in a high performance slicer, for carrying out blank cuts and/or for setting a cutting gap.

In the slicing method in accordance with an embodiment of the invention, at least one product to be sliced is fed to a cutting blade. The cutting blade is driven by means of a single electric drive motor, which may be a drive motor in accordance with the invention in accordance with the above description, to make rotational movements about an axis and to make axial movements generally parallel to the axis.

Provision may be made in this respect that the motor has a rotor having at least two electrically excitable coils, by which the rotor can be set into rotation about the axis and can be moved generally parallel to the axis, with the coils being excited in opposite senses with mutually cancelling axial components for a generally pure rotational operation and with the coils being excited by different amounts with a resulting axial component for carrying out an axial movement. Provision may be made in this respect that each coil generates an axial component (i.e. exerts a force acting on the rotor in the axial direction) with the control or excitation of the coils taking place in opposite senses for a generally pure rotational operation to the extent that these axial components compensate one another, while the control or excitation of the coils takes place with the consequence of a resulting force in the axial direction when an axial movement of the rotor should take place.

In another embodiment of the invention mentioned above, the motor has a rotor with at least one electrically excitable coil by which the rotor is set only into rotation about the axis. In a method as described, the rotor is moved generally parallel to the axis by means of an electromagnet for carrying out an axial movement.

In the method in accordance with another embodiment of the invention, the axial movement of the cutting blade may take place for carrying out blank cuts and/or for setting a cutting gap.

The cutting blade may be moved generally parallel to the axis while rotating about the axis.

### BRIEF DESCRIPTION OF THE DRAWINGS

The invention will be described in the following by way of example with reference to the drawings. There are shown:

FIG. 1 is a schematic side view of a slicing apparatus in accordance with an embodiment of the invention, including a cutting blade which can both be set into rotation and can be moved axially; and

FIG. 2 is a schematic illustration of a drive motor in accordance with an embodiment the invention with which a cutting blade can be set into rotation about an axis and can be moved parallel to the axis.

### DETAILED DESCRIPTION

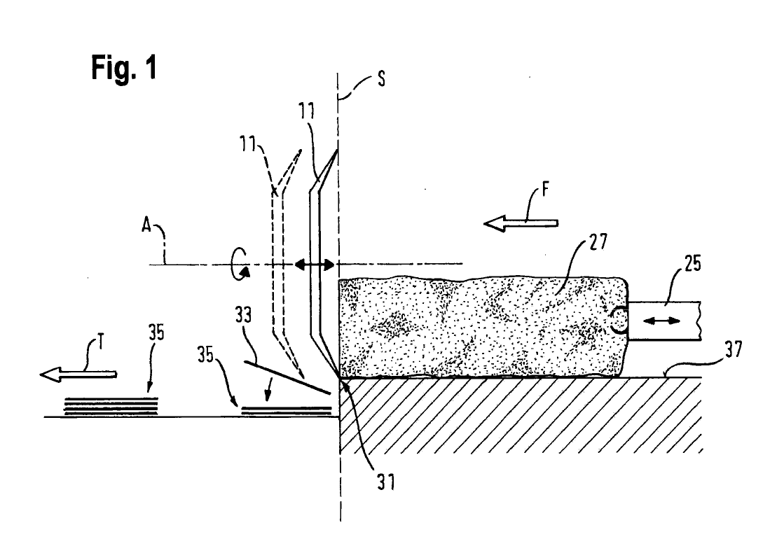

FIG. 1 shows in a schematic side view a high performance slicer in accordance with an embodiment of the invention which serves to cut food products 27 such as, for example, meat, sausage, ham or cheese into slices. During the cutting process, the product 27 lies on a product support 37 and is moved by means of a product feed along a product feed direction F in the direction of a cutting plane S. The feed direction F extends generally perpendicular to the cutting plane S. Only a so-called product holder 25 is shown of the product feed in FIG. 1, which engages with claws or grips into the rear end of the product 27, and can be driven by drive means (not shown) in and against the product feed direction F, which is indicated by the double arrow.

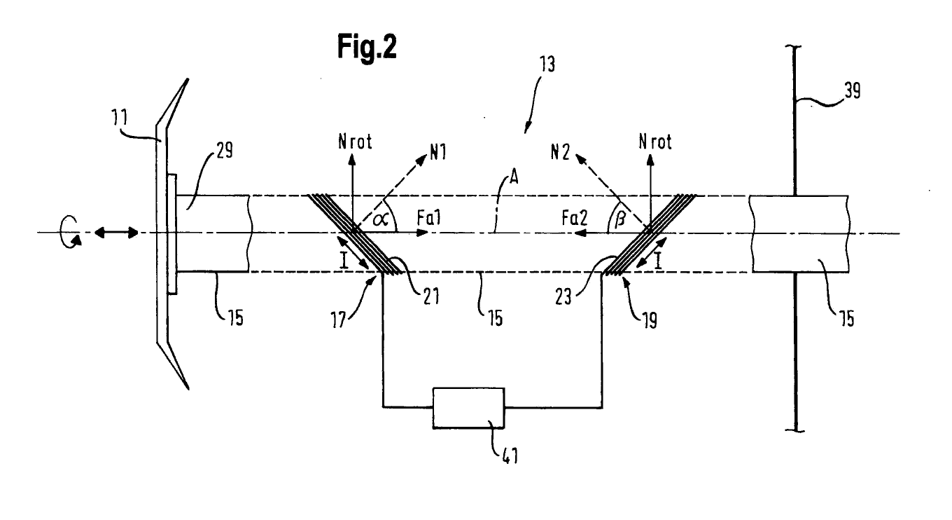

The cutting plane S is defined by a cutting edge 31 (also called a counter-blade), which forms the front end of the product support 37. During the slicing operation, the cutting edge 31 cooperates with the blade edge of a cutting blade 11. As mentioned above, the cutting blade 11 can be a so-called circular blade, which both orbits about an axis (not shown) in a planetary motion and rotates about its own axis of rotation A. Alternatively, the cutting blade 11 can be a so-called scythe-like blade or spiral blade which does not orbit in a planetary motion, but rather only rotates about the blade axis A. The drive in accordance with the invention for the cutting blade 11 is not shown in FIG. 1, but will rather be explained below in connection with FIG. 2.

The blade drive is configured to set the blade into rotation about the axis A and to move it generally parallel to the axis A, with the axial movement serving to carry out the blank cuts as discussed above. A position of the blade 11 is shown by a dashed line in which an axial spacing is present between the plane defined by the blade edge of the blade 11, on the one hand, and the cutting plane S, on the other hand. Thus, the scrap formation or snippet formation as discussed above is generally avoided.

With a portion-wise slicing of the product 27, as is shown in FIG. 1, the cut off product slices 33 form portions 35 which are shown as slice stacks in FIG. 1. As soon as a portion 35 is completed, this portion 35 is transported away in a direction T. So that sufficient time is available for the transporting away of the finished slice portions 35, the mentioned blank cuts are carried out until the start of the formation of the next portion 35, for which purpose the product feed is stopped, on the one hand, and the cutting blade 11 is moved into the position shown in FIG. 1 by means of the blade drive in accordance with an embodiment of the invention, on the other hand.

The drive motor 13 for the cutting blade 11 shown in FIG. 2 is a specific electric motor that has a rotor 15 also called an armature. The front end of the rotor 15 is configured as a blade carrier 29, to which the cutting blade 11 is replaceably fastened. The drive motor 13 is attached to a base 39 of the slicing apparatus, with this attachment being able to take place in generally any desired manner. The rotor 15 is supported both rotatably about the axis A and movable in the direction of the axis A relative to the base 39.

In accordance with an embodiment of the invention, the rotor 15 is provided with a plurality of coils, of which only two coils 17, 19 are shown in the schematic representation of FIG. 2. Each coil 17, 19 has at least one winding 21, 23 which is orientated with respect to the axis A such that the surface normal N1, N2 includes an angle α, β with the axis A which can generally adopt any desired value between about 0° to about 90°. In this embodiment, the windings 21, 23 are consequently diagonal windings.

This orientation of the coils 17, 19 has the consequence, on the one hand, that the surface normals N1, N2 of the windings 21, 23 each have a component Nᵣₒₜ generally perpendicular to the axis of rotation A. A torque setting the rotor 15 into rotation is hereby generated in accordance with the principle of a conventional electric motor when an electric current I flows through the windings 21, 23. It should be noted that the remaining components of the motor, in particular the devices for the magnetic field generation, are not shown in FIG. 2 for reasons of simplicity. It is also noted that the schematic representation of FIG. 2 serves for the explanation of the basic principle of this embodiment. The variables and vectors shown are in particular not to be understood in the sense of complete construction instructions.

The explained orientation of the coils 17, 19 has the consequence, on the other hand, that forces Fa1, Fa2 are exerted onto the rotor 15 due to the current flow through the windings 21, 21 and are directed generally parallel to the axis of rotation A. The magnitude and direction of these axial forces can be influenced by the arrangement and by the manner of the control or excitation of the coils 17, 19. An operating principle in an operating situation is shown in FIG. 2 in which the coils 17, 19 can be excited by a control device 41 such that the mentioned axial forces cancel one another out so that instantaneously substantially no axial movement of the rotor 15 takes place, with the coils 17, 19, however, together having the consequence of a resulting rotational movement of the rotor 15 about the axis A.

When an axial offset of the blade 11 is required for carrying out blank cuts and/or for setting the cutting gap, the current flow through one of the windings 21, 23 is varied, for example, whereby the rotational movement of the blade is maintained, on the one hand, but one of the axial forces dominates, on the other hand, so that a resulting axial force F is adopted, which has the consequence of an axial movement of the still rotating rotor 15 in the respective axial direction predefined by the control or excitation of the coils 17, 19.

When the original axial position of the blade 11 should be reestablished for the restarting of the cutting operation, this can take place by a corresponding control or excitation of the coils 17, 19 to temporarily affect a resulting axial force in the opposite direction (i.e. in the restoring direction). Alternatively, it is possible to work without a restoring movement affected by the coils 17, 19, when e.g. the initially taking place axial movement takes place against the effect of a restoring device (not shown in FIG. 2), for example of a spring of generally any configuration whose restoring force moves the rotor 15 together with the blade 11 axially back into the cutting position as soon as the coils 17, 19 have switched over again to a generally pure rotational operation without any substantial resulting axial force component.

As already mentioned above, the drive motor 13 in accordance with an embodiment of the invention cannot only be used for carrying out blank cuts, but also for setting a respective required cutting gap between the cutting plane of the blade and the cutting edge plane.

1-29. (canceled)

30. An apparatus for driving an object, having a cutting blade of for slicing food products, comprising:
an electric drive motor configured to drive the object to make rotational movements about an axis and to make axial movements generally parallel to the axis.

31. The apparatus in accordance with claim 30, wherein the electric drive motor is part of a high performance slicer.

32. The apparatus in accordance with claim 30, the electric drive motor being configured to carry out the axial movements simultaneously with the rotational movements.

33. The apparatus in accordance with claim 30, the electric drive motor including a rotor that is configured to be set into rotation about the axis and moved generally parallel to the axis.

34. The apparatus in accordance with claim 33, the rotor being provided with at least one electrically excitable coil.

35. The apparatus in accordance with claim 33, the rotor being provided with at least a first electrically excitable coil and a second electrically excitable coil by which the rotor is configured to be set into rotation about the axis and being movable generally parallel to the axis.

36. The apparatus in accordance with claim 35, the first electrically excitable coil and the second electrically excitable coil configured to be excited independently of one another.

37. The apparatus in accordance with claim 35, the first electrically excitable coil and the second electrically excitable coil configured to affect the rotational movements and the axial movements together.

38. The apparatus in accordance with claim 35, the first electrically excitable coil and the second electrically excitable coil configured to be at least one of arranged in opposite senses with respect to the axis and excitable in opposite senses.

39. The apparatus in accordance with claim 35, at least one of the first electrically excitable coil and the second electrically excitable coil configured having a surface generally normal with a component generally parallel to the axis.

40. The apparatus in accordance with claim 35, at least one of the first electrically excitable coil and the second electrically excitable coil having at least one diagonal winding.

41. The apparatus in accordance with claim 34, the first electrically excitable coil and the second electrically excitable coil being configured and arranged to set the rotor only into rotation about the axis.

42. The apparatus in accordance with claim 41, there being an electromagnet associated with the rotor for generating the axial movement.

43. The apparatus in accordance with claim 30, wherein the electric drive motor is configured as as a carrier for a cutting blade, or is connectable to a separate carrier for a cutting blade.

44. The apparatus in accordance claim 30, wherein the electric drive motor is configured to drive the object wherein a weight of the object is in the range from about 10 kilograms to about 100 kilograms.

45. The apparatus in accordance with claim 30, the electric drive motor being configured to set the object into rotation at a speed of about 100 to about several thousand revolutions per minute.

46. The apparatus in accordance with claim 30, the electric drive motor being configured to carry out axial movement with a length of about 1 millimeter to about 10 millimeters within a time of about 0.02 seconds to about 0.5 seconds.

47. An apparatus for slicing food products, comprising:
a product feed;
at least one cutting blade to which at least one product to be sliced is configured to be fed; and
a single electric drive motor for the at least one cutting blade, wherein the at least one cutting blade is configured to be driven by the single electric drive motor to make rotational movements about an axis and to make axial movements generally parallel to the axis.

48. The apparatus in accordance with claim 47, there being a feed direction in which the at least one product is configured to be fed to the at least one cutting blade extends generally parallel to the axis.

49. The apparatus in accordance with claim 47, the at least one cutting blade being movable generally parallel to the axis for carrying out blank cuts.

50. The apparatus in accordance with claim 47, the at least one cutting blade being movable generally parallel to the axis for setting a cutting gap.

51. A blade head for an apparatus for slicing food products, comprising
a product feed;
at least one cutting blade to which at least one product to be sliced is configured to be fed; and
a single electric drive motor for the at least one cutting blade, wherein the at least one cutting blade is configured to be driven by the single electric drive motor to make rotational movements about an axis and to make axial movements parallel to the axis, there being a carrier for the at least one cutting blade.

52. A method of slicing food products, comprising:
providing an electric drive motor configured to drive an object to make rotational movements about an axis and to make axial movements generally parallel to the axis, wherein the electric drive motor is part of an apparatus for slicing food products for at least one of carrying out blank cuts and setting a cutting gap.

53. A method for slicing food products, comprising the steps of:
feeding at least one product to be sliced to a cutting blade and driving the cutting blade by a single electric drive motor to make rotational movements about an axis and to make axial movements generally parallel to the axis.

54. The method in accordance with claim 53, the single electric drive motor having a rotor having at least a first electrically excitable coil and a second electrically excitable coil, and exciting the first electrically excitable coil and the second electrically excitable coil to set the rotor into rotation about the axis and moving generally parallel to the axis, with the first electrically excitable coil and the second electrically excitable coil being excited in opposite senses with mutually cancelling axial components for a generally pure rotational operation, and the first electrically excitable coil and the second electrically excitable coils being excited by different amounts with a resulting axial component for carrying out an axial movement.

55. The method in accordance with claim 53, the single electric drive motor having a rotor having at least one electrically excitable coil and an electromagnet, the method comprising the step of setting the rotor only into rotation about the axis using at least one electrically excitable coil, and moving the rotor axially generally parallel to the axis for carrying out an axial movement by the electromagnet.

56. The method in accordance with claim 55, the method further comprising the step of moving the cutting blade generally parallel to the axis for carrying out blank cuts.

57. The method in accordance with claim 53, the method comprising the further step of moving the cutting blade generally parallel to the axis for setting a cutting gap.

58. A method in accordance with claim 53, the method comprising the further step of moving the cutting blade generally parallel to the axis while rotating about the axis.
